(19) United States
(12) Patent Application Publication
(10) Pub. No.: US 2008/0098314 A1
(43) Pub. Date: Apr. 24, 2008

(54) Method and system for preparing and delivering an archive of information reposed on a collaborative transaction management platform

(76) Inventor: Joshua D.J. Sharfman, Los Angeles, CA (US)

Correspondence Address: CHRISTIE, PARKER & HALE, LLP, PO BOX 7068, PASADENA, CA, 91109-7068, US

(21) Appl. No.: 11/585,029

(22) Filed: Oct. 19, 2006

(51) Int. Cl. G06F 3/00

(52) U.S. Cl. 715/762; 715/764; 715/810

(57) ABSTRACT

A method and a system for preparing and delivering an archive on a computer-readable medium is provided. A platform gathers and stores data on the platform that can be viewed through a first graphical user interface over the Internet. In addition, the platform generates an archive of the data in a web browser readable format containing instructions of a second graphical user interface. The archive can be viewed offline with a web browser through the second graphical user interface. Lastly, the first graphical user interface and the second graphical user interface are substantially identical.

### BACKGROUND OF THE INVENTION

1. Field of the Invention

The present invention relates to a system and a method for preparing and delivering an archive. More specifically, the present invention relates to archiving data and/or documents from a platform onto a computer-readable medium in a format such that the archive may be viewed using substantially the same graphical user interface as is available through the platform.

2. Description of Related Art

The management of some transactions requires the organization of vast amounts of data and documents. Real estate transactions is one such example in which vast amounts of documents are generated. Certain real estate regulatory agencies may require that many of these documents be retained for a specified period of time following the close of the transaction. These retained documents may be stored electronically. For example, according to the California Department of Real Estate, a real estate broker may use electronic image storage media to retain and to store copies of all listings, deposit receipts, canceled checks, trust records, and other documents executed by the real estate broker or obtained in connection with the real estate transaction.

Given the vast amount of data and documents that are created in some transactions, a system and a method is currently needed for archiving the transaction related data and documents onto a memory medium so that the data and documents are organized and easily accessed.

### BRIEF SUMMARY OF THE INVENTION

An aspect of the present invention provides a method and a system for preparing and delivering an archive on a computer-readable medium. In one embodiment, a platform gathers and stores data and/or documents on the platform that can be viewed through a first graphical user interface over the Internet. In addition, the platform generates an archive of the data and/or documents in a web browser readable format containing instructions of a second graphical user interface. The archive can be viewed offline with a web browser through the second graphical user interface. Here, the first graphical user interface and the second graphical user interface are substantially identical.

In one embodiment, the first graphical user interface contains general components for viewing information and specific components for modifying information on the platform, and the second graphical user interface contains only the general components of the first graphical user interface for viewing information.

In one embodiment, the platform also gathers user selections and entries that define the data and/or documents stored on the platform to archive to the computer-readable medium.

In one embodiment, the platform also generates the second graphical interface of the archive in a human language based on a user selected language option.

In one embodiment, the platform limits access to add, to modify, and to delete data and/or documents depending on a user permission setting, the user permission setting being based on a first user's role in a transaction on the platform.

In one embodiment, the data and/or documents on the platform viewed through the first graphical user interface are based on a first user's role in a transaction on the platform. In addition, the archive may be generated containing the data and/or documents available based on the first user's role or the archive may be generated containing a subset of the data and/or documents, the subset being defined by a second user's role in the transaction on the platform.

In one embodiment, the platform also gathers user selections and entries that define parameters with which a CD-ROM label image is created for a CD-ROM, and generates the CD-ROM label image.

In one embodiment, the platform is a real estate collaborative transaction management platform.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 illustrates a web browser with content displayed by a first graphical user interface, whereas the web browser is running on a computer connected to the Internet, in accordance with an embodiment of the present invention.

FIG. 2 illustrates a web browser with content displayed by a second graphical user interface, whereas the web browser is running on a computer that is not connected to the Internet, in accordance with an embodiment of the present invention.

FIG. 3 is a cover sheet screen of the first graphical user interface presented by a system, in accordance with an embodiment of the present invention.

FIG. 4 is a first dialog screen presented by a system, in accordance with an embodiment of the present invention.

FIG. 5 is a top half of a second dialog screen presented by a system, in accordance with an embodiment of the present invention.

FIG. 6 is a bottom half of a second dialog screen presented by a system, in accordance with an embodiment of the present invention.

FIG. 7 is a cover sheet screen of an archived transaction displayed by the second graphical user interface, in accordance with an embodiment of the present invention.

FIG. 8 is a cover sheet screen in Spanish of an archived transaction displayed by the second graphical user interface, in accordance with an embodiment of the present invention.

FIG. 9 shows a flow chart of a collaborative transaction management platform, in accordance with an embodiment of the present invention.

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

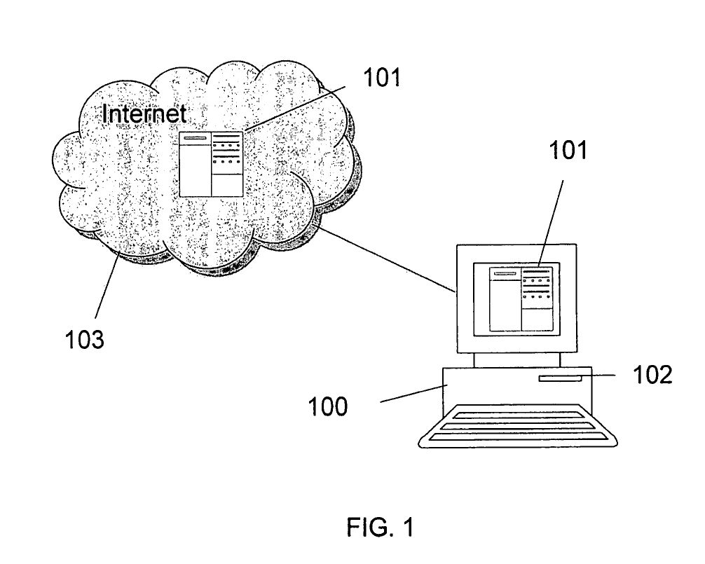

FIG. 1 through FIG. 9 show a small segment of a collaborative transaction management platform setup to manage real estate transactions, but the invention is not limited to real estate transactions only.

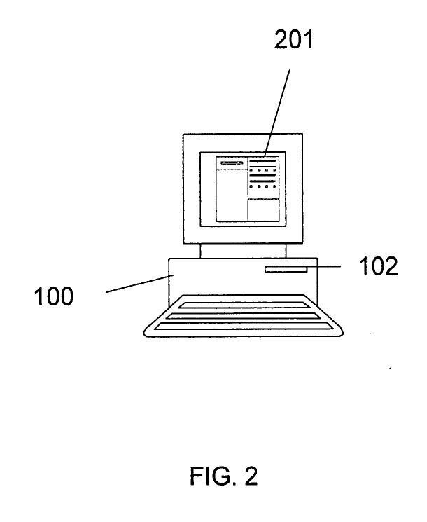

FIG. 1 illustrates a web browser with content displayed by a first graphical user interface (GUI) 101, whereas the web browser is running on a computer 100 connected to the Internet 103. FIG. 2 illustrates a web browser with content displayed by a second GUI 201, whereas the web browser is running on a computer 100 that is not connected to the Internet 103. Using the collaborative transaction management platform, users may view data and/or documents associated with a particular transaction through the first GUI 101 over the Internet 103 from a remote computer 100 using a web browser such as Internet Explorer®, Firefox®, Netscape® Communicator, or the like. Internet Explorer® is a registered trademark of Microsoft Corporation. Firefox is a registered trademark of Mozilla Foundation. Netscape® is a registered trademark of Netscape Communications Corporation.

In addition, users of the collaborative transaction management platform may archive data and/or documents of a particular transaction or transactions in HTML and JavaScript with links to files such as JPEG, GIF, PDF, and the like. The collaborative transaction management platform supports all document types and is not limited to the aforementioned file extensions. Also, in the context of the present invention, the term data can be used to refer to data in documents, data outside of documents, and/or documents themselves.

In one embodiment, the current collaborative transaction management platform archives in HTML and JavaScript, but the invention is not thereby limited. The present invention extends to all web browser readable formats. The archive may be written to a hard drive of computer 100 or any other computer-readable medium through a CD-ROM/DVD drive 102. The stored archive may later be viewed with the second GUI 201 using the same web browser running on a computer 100 that is not connected to the Internet 103. The archived transactions are stored in a format containing instructions of the second GUI 201 such that substantially the same GUI may be used to view the archived transactions as is used to view the transactions through the collaborative transaction management platform online. That is, the archived transaction content is displayed in a GUI (i.e., the second GUI 201) that is substantially the same as the first GUI 101 in which the transaction content is displayed by the collaborative transaction management platform online.

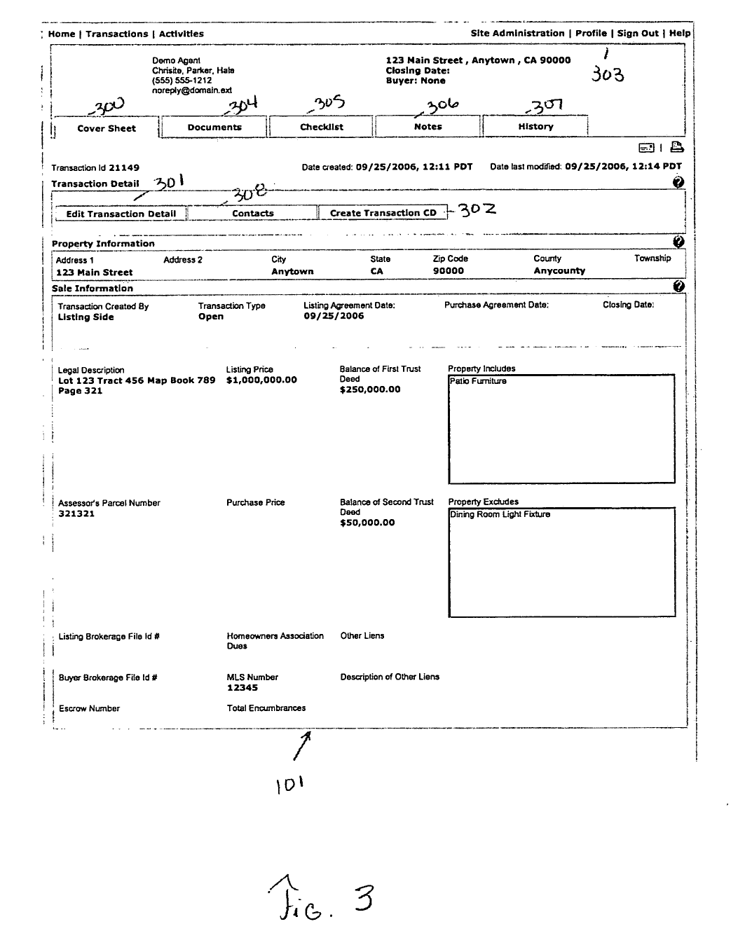

FIG. 3 shows a cover sheet screen 300 of the first GUI 101, as presented online over the Internet. The cover sheet screen 300 is part of the content displayed by the first GUI 101. The cover sheet screen 300 includes the ability to edit transaction details through button 301 and the ability to create a transaction CD-ROM through button 302. The ability to edit transaction details is limited by user privileges set for the particular transaction. That is, the system allows for user permissions to be set such that only particular users as a function of their role in the collaboration may add, modify, and/or delete data and/or documents associated with a particular transaction.

Users of the collaborative transaction management platform also have the ability to create an archive of the transaction. Users initiate the process of archiving data and/or documents associated with a transaction by selecting button 302 as shown in FIG. 3.

The collaborative transaction management platform presents transaction data and/or documents using a first GUI 101. The first GUI 101 contains components specific to usage online and components general to viewing the transaction data and/or documents. The specific components are used for writing or modifying information on the collaborative transaction management platform. The selections 301, 302, 303 are examples of specific components. The general components are used for reading/viewing the information on the collaborative transaction management platform. The menus 304, 305, 306, 307, 308 are examples of general components.

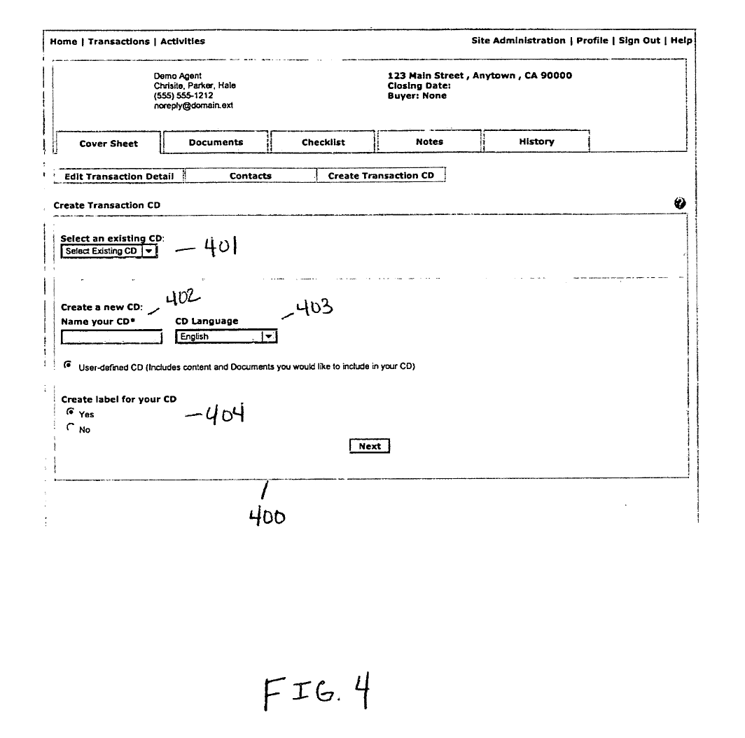

FIG. 4 shows a first dialog screen 400 as available online over the Internet. The first dialog screen 400 is part of the content displayed by the first GUI 101. The first dialog screen 400 allows users to select options for archiving data and/or documents related to a particular transaction to a computer-readable medium. Users may select to archive data and/or documents saved under an existing CD definition name or to a new CD definition name through combo box 401. That is, if a user had previously saved the transaction data and/or documents to the collaborative transaction management platform, users can load the transaction data and/or documents for the archive by selecting the associated CD definition name through combo box 401. Users may enter the name of the archived transaction through text field 402 and select a human language through combo box 403 for the second GUI 201, which displays the archived transaction data and/or documents. For example, if a user would like the archived transaction data and/or documents to be displayed by the second GUI 201 in Spanish, a user would select the Spanish option in combo box 403. In one embodiment, the collaborative transaction management platform supports languages English, Spanish, Chinese, and Vietnamese, but the present invention is not thereby limited. For example, the platform can be configured for additional suitable languages as needed. Finally, users may select in radio button 404 whether to create a label image for the face of a CD-ROM.

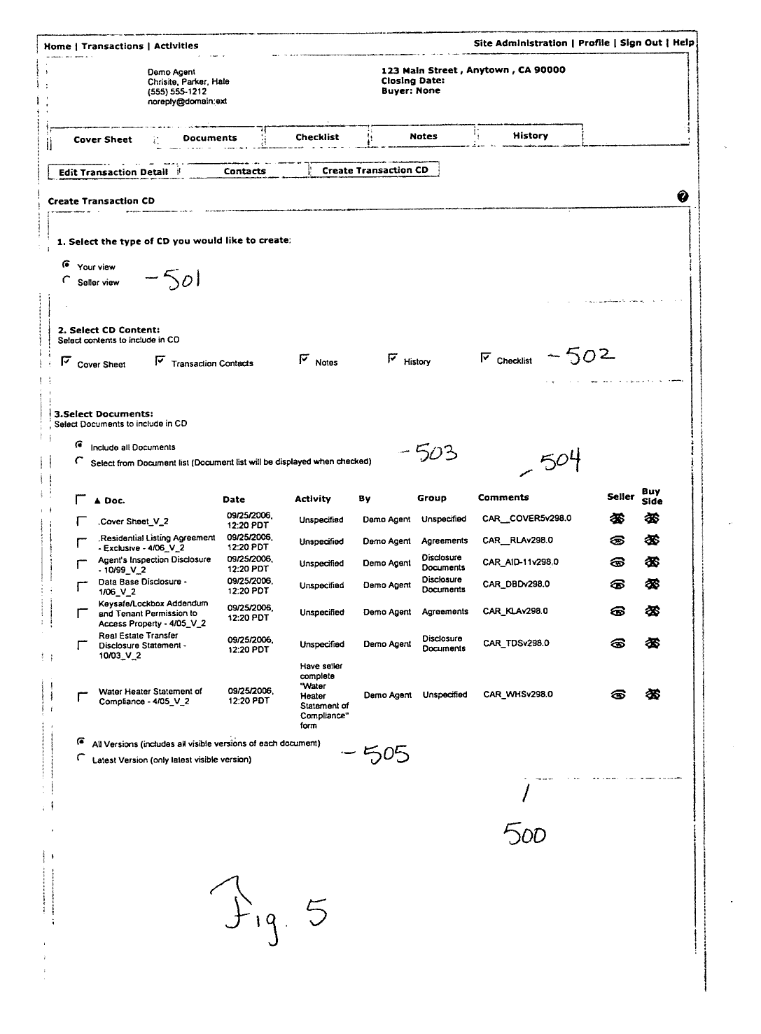

FIG. 5 shows a top half of a second dialog screen 500 that allows users to select options for archiving data and/or documents related to a particular transaction to a computer-readable medium. The second dialog screen 500 is part of the content displayed by the first GUI 101. Users may select in radio button 501 whether to display documents in check boxes 504 that are privileged to the user or privileged to the seller/buyer. The user is normally an agent or broker. The broker has the greatest access privileges, as brokers have a right to access all of the data and/or documents for a particular transaction on the collaborative transaction management platform. The agent has a right to access only a subset of what the broker has a right to access. Finally, the buyer/seller has a right to access only a subset of what the agent may access. Thus, if the user is creating a transaction archive for his or her own purposes, the user may select to view all data and/or documents within the user's privilege. The data and/or documents available to be viewed depends on whether the user is a broker, agent, or seller/buyer. If the user is creating a transaction archive for a buyer/seller, the user may limit the documents displayed in the check boxes 504 according to the privilege access of the buyer/seller.

That is, the user may view data and/or documents on the collaborative transaction management platform based on the user's role (i.e., a first user's role) in a transaction stored on the platform. In addition, the user may create an archive containing all of the data and/or documents that can be viewed under the user's access permission or the user may create an archive containing only a subset of the data and/or documents depending on the role of another user such as the buyer or seller (i.e., a second user's role).

With respect to FIG. 5, users may select in check box 502 the type of content to include in the archive, that is, whether to include data in the archive associated with the cover sheet, transaction contents, notes, history, or the checklist. Moreover, users may select in radio button 503 whether to include all documents or to include documents as selected from a list. If a user selects to include documents as selected from a list, the user may select in check boxes 504 particular documents to include. As mentioned above, the documents shown in check boxes 504 are a function of the user's selection in radio button 501. Finally, users may select in radio button 505 whether to include all versions of the selected documents or to include just the latest version of the selected documents.

Although FIG. 5 shows real estate transaction specific user selections, the invention is not thus limited. Generally, the invention includes any user selections that would facilitate archiving data and/or documents onto a computer-readable medium.

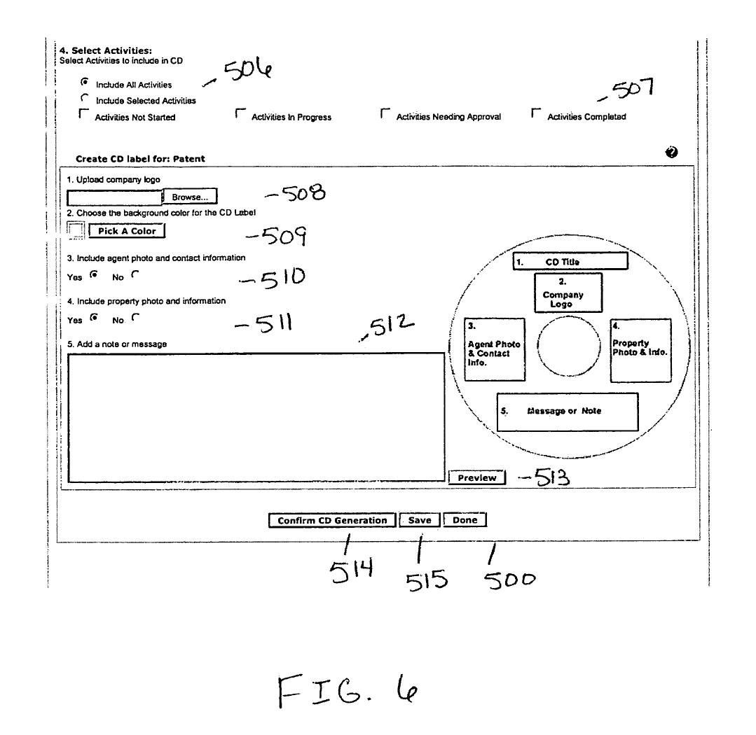

FIG. 6 shows a bottom half of the second dialog screen 500 that allows users to select options for archiving data and/or documents related to a particular transaction to a computer-readable medium. Users may select the activities to include in the archive on the computer-readable medium. Users may select in radio button 506 to include all activities or selected activities. Users may select selected activities in check box 507 such as “activities not yet started,” “activities in progress,” “activities needing approval,” and “activities completed.” In addition, if radio button 404 of FIG. 4 was checked “Yes,” users may create a CD-ROM label image for the face of a CD-ROM on which the archived transaction data may be stored. Users may upload a company logo through text field and button 508, may choose a background color through button 509, include a photo of the agent through radio button 510, include a photo of the property through radio button 511, and add notes or messages to be printed on the CD-ROM label through text area 512. In addition, users may preview the transaction CD-ROM label image through button 513. Users may generate the transaction archive for saving to a computer-readable medium through button 514. Finally, users may save user selections and data and/or documents associated with a particular transaction to the collaborative transaction management platform through button 515. If a user saves a particular transaction to the collaborative transaction management platform through button 515, the name of the archived transaction entered in text field 402 will appear in combo box 401. Users may save the archive to their hard drive or to any other computer-readable medium such as a CD-ROM or a DVD. If users save the archive to their hard drive, the CD-ROM label image is saved to the hard drive along with the archive.

Although the CD-ROM label options are shown to be specific to real estate transactions, the invention is not thus limited. The CD-ROM label image may include information specific to the particular transaction archived onto a CD-ROM, therefore the menu selections and entries in the collaborative transaction management platform may be tailored to the specific type of transactional information to be recorded onto the CD-ROM. The information placed on the CD-ROM is a function of a selection or filtering criteria that is a function of the user's role and the choices that they make dynamically.

Once a user completes the dialogs for archiving a particular transaction or transactions onto a computer-readable medium, the collaborative transaction management platform generates HTML and JavaScript to be written onto the computer-readable medium and an image to be printed onto the face of a CD-ROM. The HTML and JavaScript generated by the collaborative transaction management platform and the image created for the face of a CD-ROM are a function of the selections and entries made by the user, which are dynamically generated based on user choices and information entered through the collaboration. The HTML and JavaScript generated by the collaborative transaction management platform and the transaction data and/or documents are then archived onto a computer-readable medium in the format of the second GUI 201. That is, the collaborative transaction management platform generates HTML and JavaScript that provides a file structure to include or link to transaction data and/or document assets (e.g., documents, activities, cover sheet data, checklist data, notes data, history data, etc.). Then, the collaborative transaction management platform provides the generated code and transaction data and/or document assets to the user in the form of a transaction archive, which may then be saved to any computer-readable medium, such as a hard drive, CD-ROM, or DVD. The user may then view the transaction archive through second GUI 201.

Once archived, the transaction data and/or documents may be viewed by a web browser. The format of the archived files contain instructions of the second GUI 201 and are such that a user can view the files using the second GUI 201, which is substantially the same as the first GUI 101 provided by the collaborative transaction management platform online. Using substantially the same GUI (i.e., the second GUI 201) as the first GUI 101 facilitates review of the archived data and/or documents, as users do not have to learn a new GUI and the organization and indexing of the archive is substantially identical to the organization and indexing of the first GUI 101 presented by the collaborative transaction management platform online.

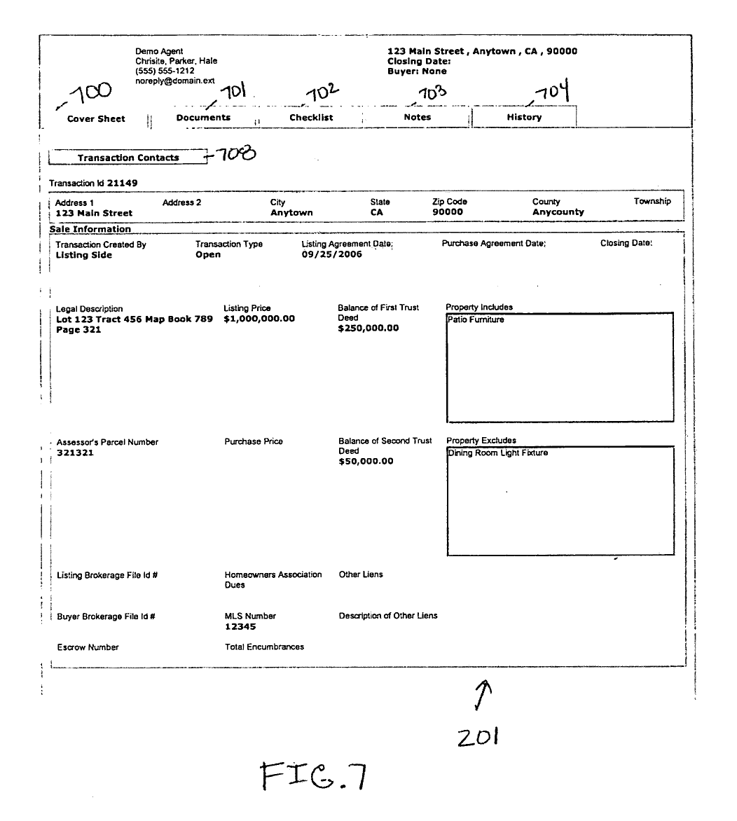

FIG. 7 shows a cover sheet screen 700 of an archived transaction viewed by the second GUI 201. The cover sheet screen 700 is part of the content displayed by the second GUI 201. The archived transactions are presented offline with substantially the same GUI (i.e., the second GUI 201) as the first GUI 101 through which the collaborative transaction management platform presents transactions online. That is, a user browsing the archived transactions offline uses the second GUI 201 with substantially the same look and feel as the first GUI 101, which is used to view the transactions through the collaborative transaction management platform online. The first GUI 101 (i.e., the online GUI) differs from the second GUI 201 (i.e., the offline GUI) by including components specific for writing or modifying information on the collaborative transaction management platform. That is, the second GUI 201 includes general components for reading/viewing the transaction data and/or documents; and the first GUI 101 includes, in addition to the general components, specific components for writing or modifying the data and/or documents on the platform. For example, the archived cover sheet screen does not include the ability to edit the transaction details through button 301, the ability to archive to a computer-readable medium through button 302, nor the ability to sign out or to manage site administration through selection of the corresponding selections 303, as these functions are specific to writing or modifying the transaction data and/or documents on the collaborative transaction management platform. The general components include the cover sheet screen 700 and menus 701, 702, 703, 704, 708, which are all used for reading/viewing the transaction data and/or documents.

Although the current collaborative transaction management platform archives transaction data and/or documents in HTML and JavaScript format, the invention is not limited to HTML and JavaScript. The archive may also be in any other browser readable format such that substantially the same GUI is used to view the transaction data and/or documents as the GUI available online through the collaborative transaction management platform.

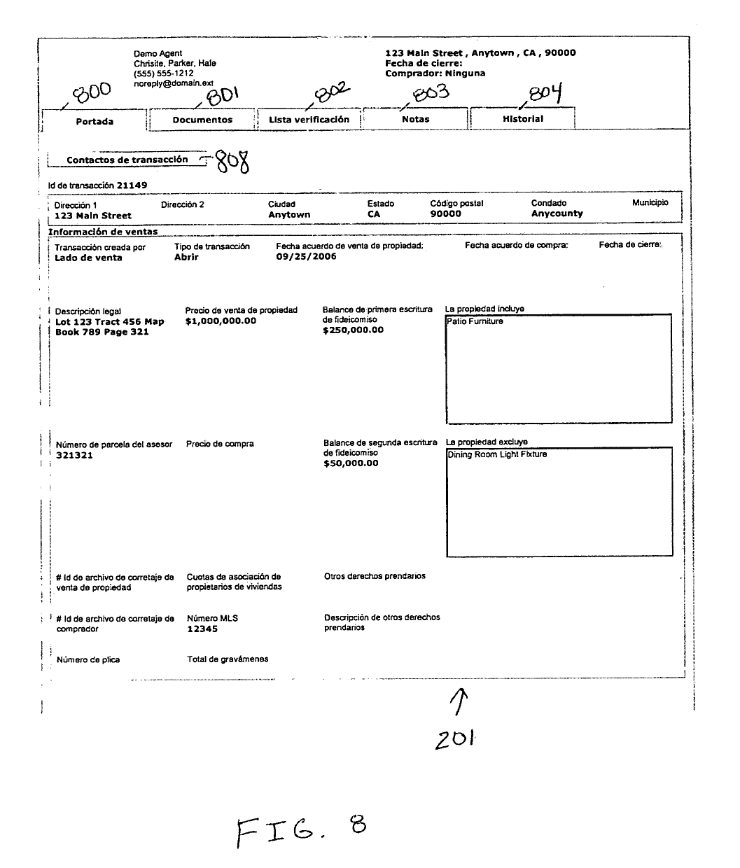

FIG. 8 shows an example of a cover sheet screen 800 of the second GUI 201 in Spanish. If a user selects Spanish in combo box 403, the second GUI 201 will be in Spanish. FIG. 8 shows only the cover sheet screen 800 in Spanish, but the screens under menus 801, 802, 803, 804, 808 are also archived in Spanish when the Spanish language option is selected.

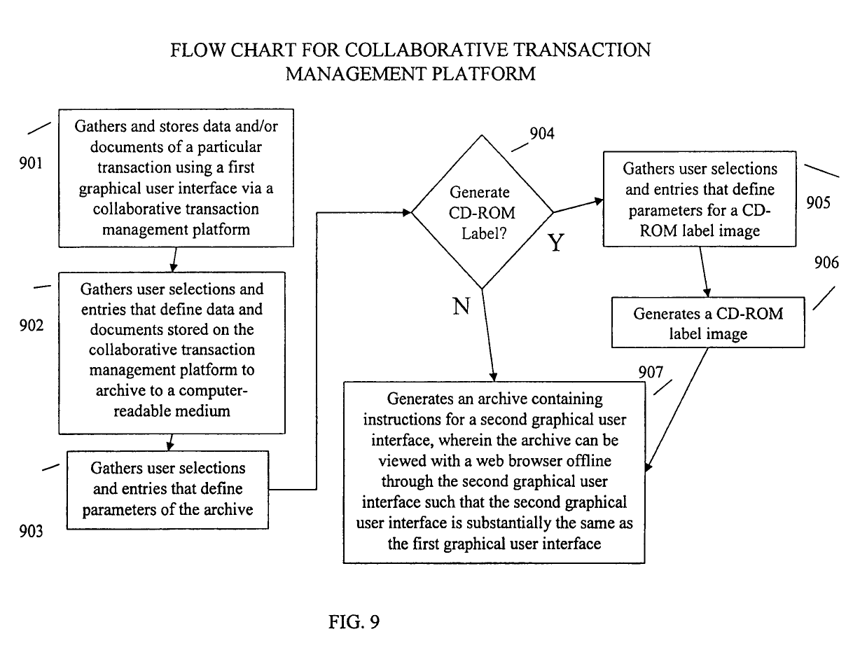

FIG. 9 shows a flow chart of one embodiment of the collaborative transaction management platform, which is available through the Internet. First, in 901 according to one embodiment, the collaborative transaction management platform using the first GUI 101 gathers and stores data and/or documents for a particular transaction or transactions onto the collaborative transaction management platform. Users may connect to the collaborative transaction management platform from a remote computer and add, modify, or delete data or documents associated with a particular transaction or transactions using the first GUI 101. Alternatively, users may add data and/or documents association with a particular transaction by FAX over the phone lines. In one embodiment, the collaborative transaction management platform limits access to add, to modify, and to delete data and/or documents according to a user permission setting that is set according to the users' role in the collaboration.

Second, in 902 according to one embodiment, the collaborative transaction management platform gathers user selections and entries that define data and/or documents stored on the collaborative transaction management platform to archive to a computer-readable medium such as a CD-ROM.

Third, in 903 according to one embodiment, the collaborative transaction management platform gathers user selections and entries that define parameters of the archive such as the view selected in 501 or the language selected in 403.

Fourth, in 904 according to one embodiment, the collaborative transaction management platform allows a user to select whether to generate a CD-ROM label image.

Fifth, in 905 according to one embodiment, if a user selected to generate a CD-ROM label image, the collaborative transaction management platform gathers user selections and entries that define parameters for a CD-ROM label image.

Sixth, in 906 according to one embodiment, the collaborative transaction management platform then generates the CD-ROM label image.

Lastly, in 907 according to one embodiment, the collaborative transaction management platform generates the archive in a format containing instructions of the second GUI 201 such that the archive can be viewed using a web browser offline through the second GUI 201, which is substantially the same as the first GUI 101 available on the collaborative transaction management platform online over the Internet.

Users may request the collaborative transaction management platform to generate a transaction archive at any time in the evolution of a transaction. The data and/or documents change through the evolution of a transaction by user input of data and/or documents, which is a function of choices, selections, and inputs that users make dynamically. Through use of the collaborative transaction management platform, users may make a snapshot of the data and/or documents on the platform at the time by requesting the platform to generate an archive.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A method for preparing and delivering an archive on a computer-readable medium, the method comprising:
gathering and storing data on a platform that can be viewed through a first graphical user interface over the Internet; and
generating an archive of the data in a web browser readable format containing instructions of a second graphical user interface, wherein the archive can be viewed offline with a web browser through the second graphical user interface, and wherein the first graphical user interface and the second graphical user interface are substantially identical.

2. The method as claimed in claim 1, wherein:
the first graphical user interface contains general components for viewing information and specific components for modifying information; and
the second graphical user interface contains only the general components of the first graphical user interface for viewing information.

3. The method as claimed in claim 1, further comprising gathering user selections and entries that define the data stored on the platform to archive to the computer-readable medium.

4. The method as claimed in claim 1, further comprising:
generating the second graphical interface of the archive in a human language based on a user selected language option.

5. The method as claimed in claim 1, wherein the platform limits access to add, to modify, and to delete data depending on a user permission setting, the user permission setting being based on a first user's role in a transaction on the platform.

6. The method as claimed in claim 1,
wherein the data on the platform viewed through the first graphical user interface are based on a first user's role in a transaction on the platform; and
wherein the archive can be generated containing the data available based on the first user's role or the archive can be generated containing a subset of the data, the subset being defined by a second user's role in the transaction on the platform.

7. The method as claimed in claim 1, further comprising:
gathering user selections and entries that define parameters with which a CD-ROM label image is created for a CD-ROM; and
generating the CD-ROM label image.

8. The method as claimed in claim 1, wherein the platform is a real estate collaborative transaction management platform.

9. A method for preparing and delivering an archive on a computer-readable medium, the method comprising:
gathering and storing data related to a particular transaction on a collaborative transaction management platform that can be viewed through a first graphical user interface over the Internet, wherein the collaborative transaction management platform limits access to add, to modify, and to delete data depending on a user permission setting, the user permission setting being based on a first user's role in the particular transaction on the collaborative transaction management platform; and
generating an archive of the data in a web browser readable format containing instructions of a second graphical user interface, wherein the archive can be viewed offline with a web browser through the second graphical user interface, and wherein the first graphical user interface and the second graphical user interface are substantially identical.

10. The method as claimed in claim 9, wherein:
the first graphical user interface contains general components for viewing information and specific components for modifying information on the collaborative transaction management platform; and
the second graphical user interface contains only the general components of the first graphical user interface for viewing information.

11. The method as claimed in claim 10, further comprising gathering user selections and entries that define the data stored on the platform to archive to the computer-readable medium.

12. The method as claimed in claim 11, further comprising:
generating the second graphical interface of the archive in a human language based on a user selected language option.

13. The method as claimed in claim 12,
wherein the data on the platform viewed through the first graphical user interface are based on the first user's role in the particular transaction on the collaborative transaction management platform; and
wherein the archive can be generated containing the data available based on the first user's role or the archive can be generated containing a subset of the data, the subset being defined by a second user's role in the particular transaction on the collaborative transaction management platform.

14. The method as claimed in claim 13, further comprising:
gathering user selections and entries that define parameters with which a CD-ROM label image is created for a CD-ROM; and
generating the CD-ROM label image.

15. The method as claimed in claim 14, wherein the collaborative transaction management platform is a real estate collaborative transaction management platform.

16. A system for preparing and delivering an archive on a computer-readable medium, the system comprising a memory medium, the memory medium including machine readable instructions stored in the memory medium that, when executed by a processor, enables a computer:
to gather and to store data on a platform that can be viewed through a first graphical user interface over the Internet; and
to generate an archive of the data in a web browser readable format containing instructions of a second graphical user interface, wherein the archive can be viewed offline with a web browser through the second graphical user interface, and wherein the first graphical user interface and the second graphical user interface are substantially identical.

17. The system as claimed in claim 16, wherein:
the first graphical user interface contains general components for viewing information and specific components for modifying information on the platform; and
the second graphical user interface contains only the general components of the first graphical user interface for viewing information.

18. The system as claimed in claim 16, wherein the memory medium including the machine readable instructions stored in the memory medium that, when executed by a processor, further enables a computer:
to gather user selections and entries that define the data stored on the platform to archive to the computer-readable medium.

19. The system as claimed in claim 16, wherein the memory medium including the machine readable instructions stored in the memory medium that, when executed by a processor, further enables a computer:
to generate the second graphical interface of the archive in a human language based on a user selected language option.

20. The system as claimed in claim 16 wherein the platform limits access to add, to modify, and to delete data depending on a user permission setting, the user permission setting being based on a first user's role in a transaction on the platform.

21. The system as claimed in claim 16,
wherein the data on the platform viewed through the first graphical user interface are based on a first user's role in a transaction on the platform; and
wherein the archive can be generated containing the data available based on the first user's role or the archive can be generated containing a subset of the data, the subset being defined by a second user's role in the transaction on the platform.

22. The system as claimed in claim 16, wherein the memory medium including the machine readable instructions stored in the memory medium that, when executed by a processor, further enables a computer:
to gather user selections and entries that define parameters with which a CD-ROM label image is created for a CD-ROM; and
to generate the CD-ROM label image.

23. The system as claimed in claim 16, wherein the platform is a real estate collaborative transaction management platform.

24. A system for preparing and delivering an archive on a computer-readable medium comprising:
means for gathering and storing data related to a particular transaction on a collaborative transaction management platform that can be viewed through a first graphical user interface over the Internet, wherein the collaborative transaction management platform limits access to add, to modify, and to delete data depending on a user permission setting, the user permission setting being based on a first user's role in the particular transaction on the collaborative transaction management platform; and
means for generating an archive of the data in a web browser readable format containing instructions of a second graphical user interface, wherein the archive can be viewed offline with a web browser through the second graphical user interface, and wherein the first graphical user interface and the second graphical user interface are substantially identical.

25. The system as claimed in claim 24, wherein:
the first graphical user interface contains general components for viewing information and specific components for modifying information on the collaborative transaction management platform; and
the second graphical user interface contains only the general components of the first graphical user interface for viewing information.

26. The system as claimed in claim 25, further comprising means for gathering user selections and entries that define the data stored on the platform to archive to the computer-readable medium.

27. The system as claimed in claim 26, further comprising:
means for generating the second graphical interface of the archive in a human language based on a user selected language option.

28. The system as claimed in claim 27,
wherein the data on the platform viewed through the first graphical user interface are based on the first user's role in the particular transaction on the collaborative transaction management platform; and
wherein the archive can be generated containing the data available based on the first user's role or the archive can be generated containing a subset of the data, the subset being defined by a second user's role in the particular transaction on the collaborative transaction management platform.

29. The system as claimed in claim 28, further comprising:
means for gathering user selections and entries that define parameters with which a CD-ROM label image is created for a CD-ROM; and
means for generating the CD-ROM label image.

30. The system as claimed in claim 29, wherein the collaborative transaction management platform is a real estate collaborative transaction management platform.
